(19) United States
(12) Patent Application Publication
(10) Pub. No.: US 2007/0186871 A1
(43) Pub. Date: Aug. 16, 2007

(54) Adjustable electrodes for pet collar

(75) Inventor: Randal D. Boyd, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/356,355

(22) Filed: Feb. 16, 2006

(51) Int. Cl. A01K 27/00; A01K 15/00

(52) U.S. Cl. 119/859

(57) ABSTRACT

An electrode useful in an animal containment or training device. The electrode is mounted in a housing adapted to be affixed to an animal such that the distal end of the electrode is proximate the skin of the animal. When a control signal is transmitted to the animal via the electrode, the distal end of the electrode extends from the housing and into electrically conductive engagement with the skin of the animal. At other times, the electrode is withdrawn from engagement with the skin of the animal. In one embodiment, the overall length of the electrode is adjustable to select the pressure exerted by the electrode against the skin of the animal.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to pet collars having electronic action-urging devices which employ electrodes in engagement with the skin of the pet for transmission to the pet of a mild electroshock.

### BACKGROUND OF THE INVENTION

Collars for pets, particularly dogs and cats, commonly are provided with pet behavioral control devices of at least two types. A first type comprises a dispenser adapted to spray a fluid onto or near a preselected anatomical feature of the pet when the pet acts or performs in an undesirable manner. These devices do not include electrodes in contact with the skin of the pet. They are commonly are activated by sound, such as barking of a dog to which the device is affixed. A second and more prevalent type of pet behavioral control device includes an electronically activated device useful in transferring a radio frequency signal from a remote transmitter to the pet in the form of a mild electrical shock. Such devices are useful in training pets, such as hunting dogs, and in “invisible” containment systems wherein a pet's physical roaming territory is defined by a buried conductor, remote transmitter or the like, carrying a signal which is transmitted to a pet in the form of an electroshock upon the pet approaching the boundary of a containment area established by a transmitted signal. These devices employ a pair of electrodes which are in electrically conductive engagement with the skin of the pet. For successful operation of an electronic control device, it is imperative that these electrodes be initially positioned, and subsequently maintained, in good electrical communication with the skin of the pet. Commonly these electronic devices include a housing mounted on a pet collar with the electrodes thereof projecting from the housing in position, usually on the pet's neck, both the electrodes in firm engagement with the skin of the pet for the effective receipt of a signal from a remote location, and proper transfer of the received signal to the pet in the form of a mild electronic shock. Heretofore, it has been common practice to form the electrodes of a nonflexible, electrically conductive material to ensure that the electrodes firmly engage the skin of the pet when the housing/collar combination is affixed to the pet, most commonly affixed about the pet's neck.

In the prior art electronic devices referred to above, it has been noted that continuous engagement of electrodes of the prior art with the skin of the pet can cause irritation and possible damage to the pet's skin at the location of the electrodes. Desirably, but not heretofore available, is an electrode which firmly and effectively engages the skin of the pet only when it is necessary to apply an electroshock to the pet. Alternatively, but less desirable, the electrodes may be affixed in less than firm engagement with the skin of the pet, but in position to respond to an activation which extends the electrodes into the desired firm electrical engagement with the skin of the pet only when it becomes necessary to apply an electroshock to the pet, and which returns to its initial position of less than firm engagement with the skin of the pet following cessation of the electroshock.

### BRIEF SUMMARY OF THE INVENTION

In accordance with one aspect of the present invention, there is provided an electronic device, usually a radio frequency receiver or a transceiver which can both send and receive radio frequency or electrical signals (the term “receiver” being deemed to be generic of these type devices for purposes of clarity in the present application), comprising a housing affixed to a collar adapted to encircle a pet's neck and position the electrodes of the electronic device in simultaneous engagement with the pet's outer skin. In one embodiment the bottom surface or perimetral edge of the receiver housing-bearing collar lies flat against the animal's skin and positions that end of the receiver housing which carries the electrodes and to which the collar is integrated, oriented substantially coplanar and in intimate, but non-electrically communicative, relationship with the pet's skin. At least first and second electrodes are mounted on the bottom of the housing and include respective electrically conductive distal tips which are disposed in facing relationship to the skin of the pet.

In accordance with one aspect of the present invention, when the receiver housing/collar combination is placed about the pet's neck, such electrodes are disposed spaced apart from the skin of the pet to the extent that the distal tips of the electrodes are not initially in electrically conductive engagement with the skin of the pet, but which are extendable to the extent that their distal tips can selectively be moved into firm electrical engagement with the skin of the pet, and which disengage the skin of the pet and return to their non-electrically conductive positions upon cessation of an electroshock event. Further, in other embodiments, the degree and or type of physical engagement, hence electrically conductive engagement, of the distal tip of the electrode is established and maintained at those values which provide acceptable electrical conductivity with the skin of the pet, but wherein the degree or extent of extensibility of the distal tip from the electrode housing is limited to that degree which does not result in certain discomforts or medical problems for the pet.

In one embodiment of the present invention, the electrode of the device may comprise a distal tip which is reciprocatably mounted within a housing. This distal tip is extendable and retractable between a first position of electrical disengagement with the skin of the pet and a second position comprising any of multiple selectable degrees of electrically conductive engagement, or full non-engagement, with the skin of the pet. In this embodiment of the electrode of the present invention, movement of the distal tip between its first and second positions may be effected employing an electroactive polymer actuator or like ionic actuator.

In accordance with yet another embodiment of the present invention, the electrode may comprise a multi-piece, generally tubular, housing, commonly a two-piece housing. In this embodiment, the two pieces of the housing are connected by threads in a manner which permits the overall length of the housing to be adjusted over a distance equal to the length of the threads. In this embodiment, the distal tip of the electrode is fixedly mounted within an outboard piece of the housing in position to engage the skin of the pet. Selection of the degree of engagement with the skin of the pet is selectable by selection of the overall length of the electrode through the action of rotating one piece of the housing relative to the other piece of the housing. In this embodiment, the electrode includes an electrical conductor leading from the distal end of the electrode through the hollow of the housing to a source of electrical power. This electrical conductor may be chosen to be extensible and capable of being twisted multiple turns to accommodate the adjustment of the overall length of the electrode. Metallic rubber, coiled wire, or other like materials serve in this function. As desired a rigid solid electrical wire may be employed with provisions for mounting of the same both linearly slideably and rotatably within that piece of the housing which does not include the distal tip, provisions being made for electrical connection to the power source that accommodates the linear movement and rotation of the rigid conductor.

In accordance with one embodiment of the present invention, the electrode may comprise an electrically conductive distal tip is mounted for linear sliding movement within a first piece of a two-piece housing the housing over a relatively short distance (e.g., less than the overall length of the distal tip) in a first piece of a two-piece housing and projects therefrom in position to engage the skin of a pet when the device is affixed about the neck of the pet, for example. This distal tip is coil spring-biased toward its most extended position, but the compression strength of the coiled spring is chosen to urge the distal tip of the electrode outwardly of the housing with a force which is sufficient to ensure acceptable electrically conductive engagement of the distal tip with the skin of the pet, but which is not sufficient to cause harm or undue irritation to the pet. This embodiment offers the advantage of allowing the distal tip of the electrode to “float” over the skin of the pet as the pet moves its head, etc., while remaining in effective electrically conductive relationship to the skin, thereby reducing the time which the distal tip remains at a single location on the skin of the pet. In short, the distal tip of the electrode does not engage the skin of the pet with a force which causes the distal tip of the electrode to materially embed itself in the skin of the pet as will create discomfort to the pet or the occasioning of medical skin problems in the area of engagement of the electrode with the pet. This embodiment of the present invention offers the advantage of selecting electrodes having an overall length which is compatible with the coat type of the pet, such as a longer electrode for heavy coats and shorter electrodes for “short-hair” pets. In any chosen overall length of the electrode, there exists the flexing nature of the engagement of the distal tip of the electrode with the skin of the pet.

In either embodiment, the outboard end of each electrode may be formed of an electrically insulative material which is relatively soft, smooth or otherwise non-irritating to the skin of the pet even when such outboard end of the electrode (not including the electrically conductive distal tip of the electrode) is in physical engagement with the skin of the pet. Moreover, in the present invention, the size and geometry of the outboard end of the electrode is substantially un-constrained and can be chosen to provide maximum comfort and be medically non-harmful to the skin of the pet.

### BRIEF DESCRIPTION OF THE SEVERAL VIEWS OF THE DRAWINGS

FIG. 1 is a side elevation view of one embodiment of an electrode useful in the present invention:

FIG. 2 is a top view of the electrode depicted in FIG. 1;

FIG. 3 is a representation of one embodiment of an electrode embodying various features of the present invention, including a two-piece electrode housing having overall length adjustability and including an electrical conductor in the form of a resilient extensible and flexible straight electrical conductor extending between the two-pieces of the housing;

FIG. 4 is a representation of the embodiment depicted in FIG. 3 wherein the electrical conductor is in the form of a coiled spring of an extensible and flexible electrically conductive material;

FIG. 5A is a representation, in section, of one embodiment of an electrode embodying various features of the present invention, including “spring-loaded” actuation of linear movement of a floating distal tip of the electrode;

FIG. 5B is a representation, in section, of the embodiment of an electrode as depicted in FIG. 5A, but having greater overall length;

FIG. 6 is a representation of one embodiment of an electrode embodying various of the features of the present invention, including electroactive polymer (EAP) type actuation of the extension and retraction of the distal tip relative to its housing; and,

FIG. 7 is a representation of one embodiment of an electrode embodying various of the features of the present invention, including a bimorph electronic type actuation of the extension and retraction of the distal tip relative to its housing.

### DETAILED DESCRIPTION OF THE INVENTION

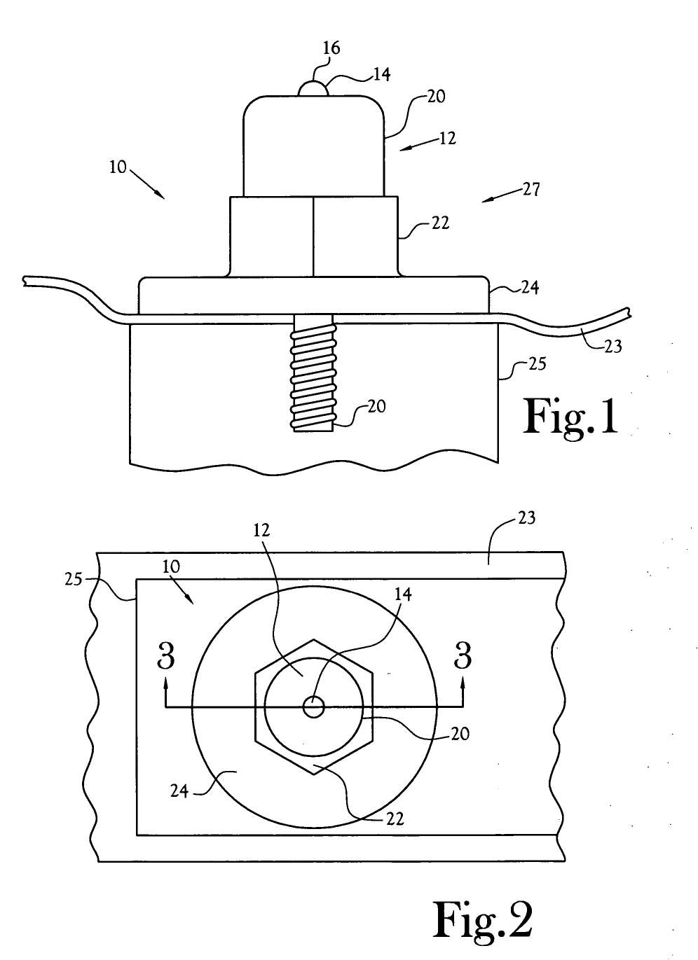

Referring initially to FIGS. 1-3, one embodiment of an electrode 10 useful in the present invention includes a hollow (generally tubular) two-piece electrically insulative hollow housing 12 within which there is mounted an electrically conductive distal tip 14 having a rounded outboard end 16 which is adapted to engage the skin of pet and establish electrically conductive engagement with the skin of the pet.

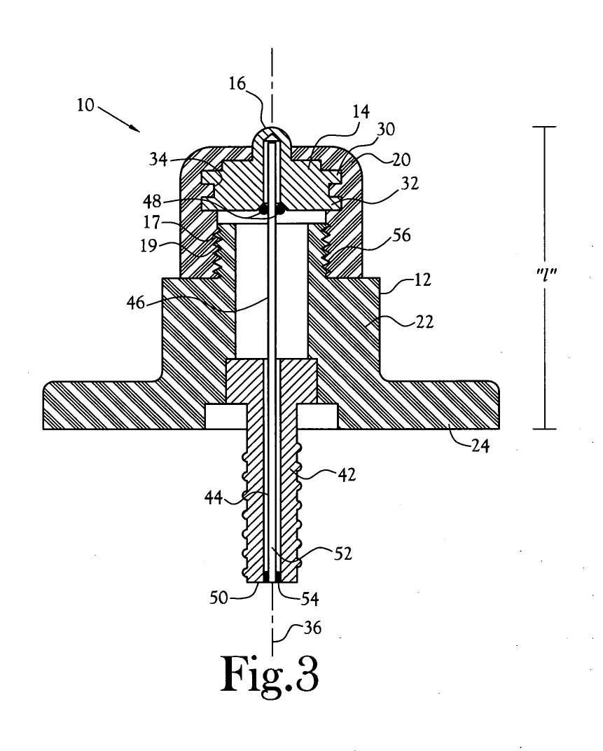

Referring to FIG. 3, the depicted housing includes a first outboard section 20 which is affixed to a second inboard section 22, as by mating sets of threads 17 and 19. The inboard second section 22 includes a base 24 which is adapted to provide for securing the electrode to a collar 23/receiver housing 25 combination, and ultimate mounting of the electroshock device 27 about the neck of a pet. Only one electrode is depicted, but it will be readily understood by one skilled in the art that two electrodes are employed with each device for purposes of administering of an electroshock to the pet to which the device is affixed.

The electrode depicted in FIG. 1 comprises a distal tip 14 having first and second laterally extending and spaced apart circumferential flanges 26, 28, respectively. These flanges are fixedly received within respective annular grooves 30,32 defined on the interior wall 34 of the housing such that the distal tip is moveable linearly along a path oriented parallel to the longitudinal centerline 36 of the electrode housing upon the rotation of the first section 20 of housing relative to the second section 22 of the housing, hence the overall length “l” of the electrode from its base 24 to the outboard end 16 of the distal tip may be selected by screwing the first and second sections of the housing relative to one another over a distance at least substantially equal to the length of the threads 15 and 17 which join the two housing sections to one another.

In the depicted embodiment, the second section of the electrode housing includes a threaded stud 42 anchored in the base of the second section useful for replaceably mounting of the electrode on the receiver housing 25, In the depicted embodiment, such stud is provided with a central throughbore 44. Internally of the hollow housing there is contained a straight electrically conductive element 46, e.g. formed of a metallic rubber material, which is anchored 48 in electrically conductive relationship to, and extends between the distal tip and the inboard end 50 of the stud. The inboard end 52 of this conductor is anchored 54 to the inboard end of the stud. As is well known in the art, this electrical conductor is electrically connected at its inboard end 52 to a power source (not shown) through well known electronics contained within the receiver housing.

In the present invention, there are at least two electrodes of opposite polarity employed in combination with a receiver housing 25 mounted on a collar 23 adapted to encircle the neck of a pet. By this means, the two electrodes may be positioned to simultaneously engage the skin of the pet in electrically conductive relationship for transmission of an electroshock, for example, to the skin of the pet. The construction of the receiver housing and the electronics required to receive and transmit signals from a remote source to the pet in the form of a mild electroshock are will known in the art and need not be described herein.

With reference to FIG. 3, as noted, the overall length “l” of the electrode 10, as measured from its base 24 to the outboard end 16 of the distal tip 14, may be selected by means of the threaded joinder of the first and second sections of the electrode housing. It will be recognized that the length of the screw threads employed to join the first and second sections of the electrode housing, may be selected to provide more or less range of adjustability of the overall length of the electrode. This feature of the embodiment of the present invention depicted in FIG. 3, is made possible through the use of a resilient, flexible (both resilient in length and resilient when twisted) electrical conductor extending between the distal tip and the base of the stud.

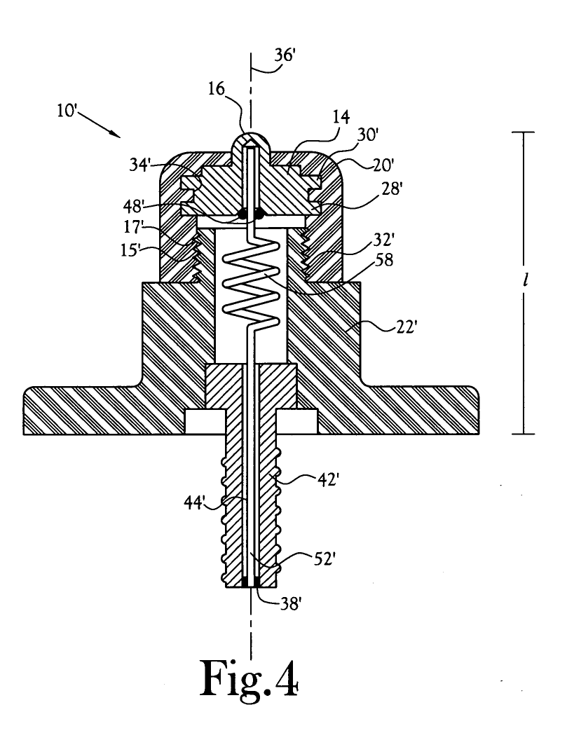

With reference to FIG. 4, there is depicted a further embodiment of substantially the same type structure for the electrode as depicted in FIG. 3, like elements of FIGS. 3 and 4 being identified by primed numerals. Specifically, in FIG. 4, a coiled wire 58, such as a copper wire, is substituted for the straight electrical conductor 46 depicted in FIG. 3. In either of the embodiments depicted in FIGS. 3 and 4, the treaded joinder of the first and second sections of the electrode housing provide a ready and speedy means for selection of the overall length of the electrode, thereby providing a user with the ability to choose the degree of engagement of the distal tip of the electrode with the skin of a pet about whose neck the collar is affixed. This choice of electrode length is particularly useful for accommodating different coat thickness of different pets, using the same electrode.

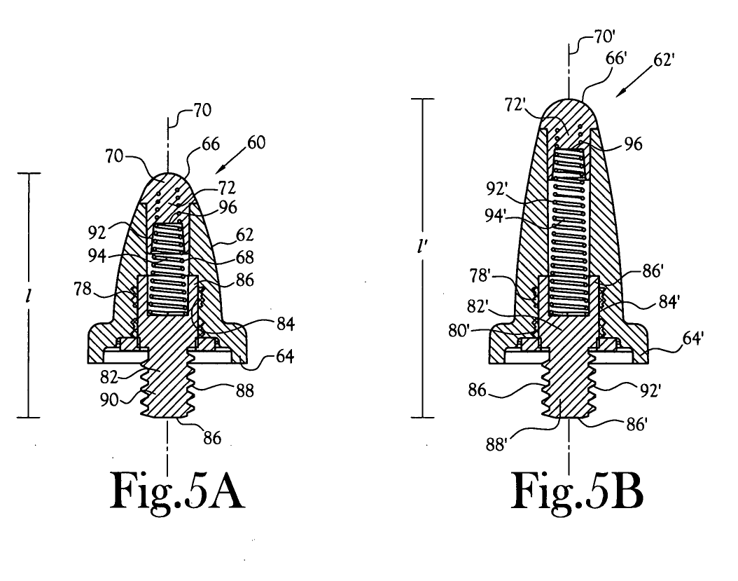

FIGS. 5A and 5B depict separate versions of a further electrode 60 useful in the present invention. In FIGS. 5A and 5B, like components of the depicted electrodes are designated with primed numerals.

Each of the embodiments depicted in FIGS. 5A and 5B, includes a one-piece housing 62, 62′, respectively. Each electrode housing, housing 62 for example, of the depicted electrode is of generally conical geometry having an inboard base 64 and an outboard end 66. Each electrode is provided with a central throughbore 68 which extends along the longitudinal centerline 70 of the housing from its base to its outboard end. Within the outboard end of the housing, there is affixed, e.g., press fitted, a distal tip 70 which is electrically conductive. The inboard end 72 of the distal tip 71 is anchored in the open outboard end 74 of the housing with a rounded outboard end 76 of the distal tip protruding from the outboard end of the housing in position to engage the skin of a pet when the electroshock device is affixed to a pet.

Again referring to FIGS. 5A and 5B, the inboard end 78 of the throughbore 68 of the electrode housing in provided with a set of internal threads 80. An electrically conductive stub shaft 82 having a first set of external threads 84 on an inboard end 86 thereof, is threaded into the internal threads 80 to provide for linear adjustment of the overall length “l” of the electrode by means of screwing the stub shaft more or less into the throughbore of the electrode housing 62. For replaceable mounting of the electrode in a receiver housing, the outboard end 88 of the stub shaft is provided with external threads 90 designed to matingly engage suitable threads within a receiver housing.

Within the central portion 92 of the throughbore 68, there is provided a coiled spring 94 of an electrically conductive material. One end 96 of the spring is disposed in electrically conductive relationship to the distal tip 70 of the electrode 60 while the opposite end 79 of the spring is disposed in electrically conductive relationship with the stub shaft 82. In one embodiment, such electrically conductive relationships may comprise mere sliding contact between the respective ends of the spring and the distal tip and the stub shaft, such contacts being established and maintained by placing the spring in compression. Other modes of effecting electrical conductive between the spring, the distal tip and the stub shaft will be apparent to one skilled in the art. It will be noted that the overall length of the electrode 60 of FIG. 5A is shorter than the overall length of the electrode 60′ depicted in FIG. 5B. The structure of the electrode depicted in FIGS. 5A and 5B permits one not only to enjoy the benefits of adjustability of the overall length of either electrode through adjustment of the position of the stub shaft within the inboard end of the electrode housing, but also permits one to initially choose a longer or shorter electrode housing as a given situation dictates. and to swap out different lengths of electrodes at will. Permissible overall lengths of electrodes thus may range over a wide spectrum, and if desired, one electrode of a given electroshock device may be longer than the other of the electrodes of the same device.

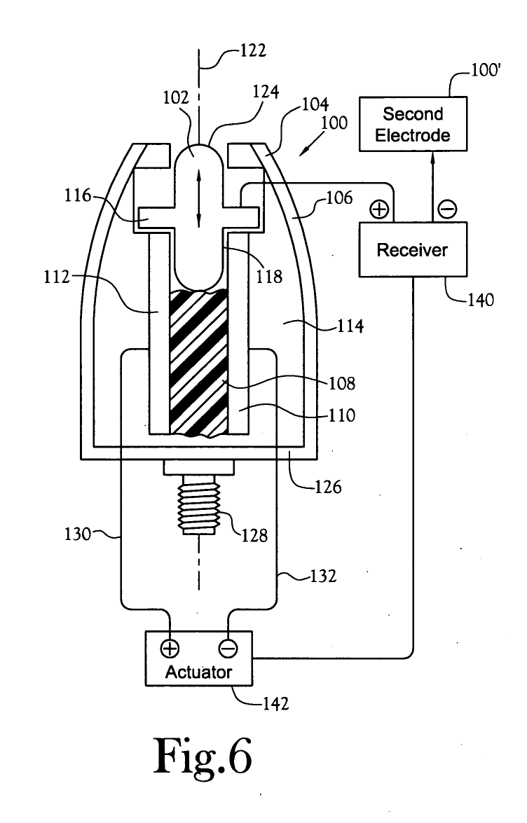

With reference to FIG. 6, there is depicted a further embodiment of an electrode 100 of selectable length. The electrode depicted in FIG. 6 is of the electroactive polymer activated type. That is, the electrode includes a distal tip 102 of electrically conductive material which is mounted in the outboard end 104 of an electrode housing 106 for reciprocating movement relative to the housing. Actuation of the movement of the distal tip is effected by the action of an electroactive polymer (EAP) contained between opposing parallel electrically conductive plates, 110,112 which, in turn are contained within a hollow central portion 114 of the electrode housing. Suitable electroactive polymers may include gels, polymer-metal composites, conductive polymers and carbon nanotubes.

More specifically, in the electrode 100 depicted in FIG. 6, there is provided a generally conically shaped hollow housing 106 of an electrically insulative material. There is mounted in the outboard end 104 of the housing an electrically conductive distal tip 102. The depicted distal tip includes a circumferential flange 116 extending outward from the outer wall 118 of the distal tip. This flange is received within an annular groove 120 of a size which permits sliding movement of the distal tip in a linear direction parallel to the longitudinal centerline 122 of the electrode housing 106. The limits of such movement of the distal tip are defined by the linear dimension of the annular groove. In the depicted embodiment, the annular groove permits the distal tip to move inwardly of the electrode housing by a distance sufficient to position the distal tip either fully or substantially within the outboard end of the electrode housing, and to be moved outwardly of the outboard end of the electrode housing a distance sufficient to permit the outboard rounded end 124 of the distal tip to engage the skin of a pet to which the electroshock device is affixed. In the depicted embodiment, within the base 126 of the electrode housing there is mounted a threaded stud 128 useful for replaceable mounting of the electrode to a receiver housing.

Movement of the distal tip is effected by the electroactive polymer disposed within the electrode housing. More specifically, when a positive electrical charge 130 is applied to the plate 112 and a negative electrical charge 132 is applied to the opposite one 110 of the plates, there occurs ionic motion within the electroactive polymer which causes the polymer to expand. Being constrained to linear expansion by reason of its mounting within the central portion of the electrode housing, the polymer expands linearly urging the distal tip outwardly of the outboard end of the electrode housing and thereby positioning the rounded end of the distal tip for engagement with the skin of a pet to which the electroshock device is affixed.

In the depicted embodiment, the distal tip 102 is bonded to the polymer 103 so that upon reversing the polarity of the opposing plates 110, 112, the polymer contracts, thereby pulling the distal tip out of engagement with the skin of the pet and back into the electrode housing.

Electronic circuitry for effecting the actuation of the distal tip between extended and contracted positions may include a receiver of known construction for receiving a radio frequency signal, for example, from a remote location and generation and transmission of an electroshock to a pet to which the device is affixed. Further, the circuitry includes a source of dc voltage of at least about 2 volts (e.g. an actuator 142 to the opposing plates associated with the electroactive polymer, along with appropriate switching of polarities between the plates, as desired, all such circuitry being known by a person skilled in the art to which the present invention relates. A complete electroshock device includes at least two electrodes 100 and 100′.

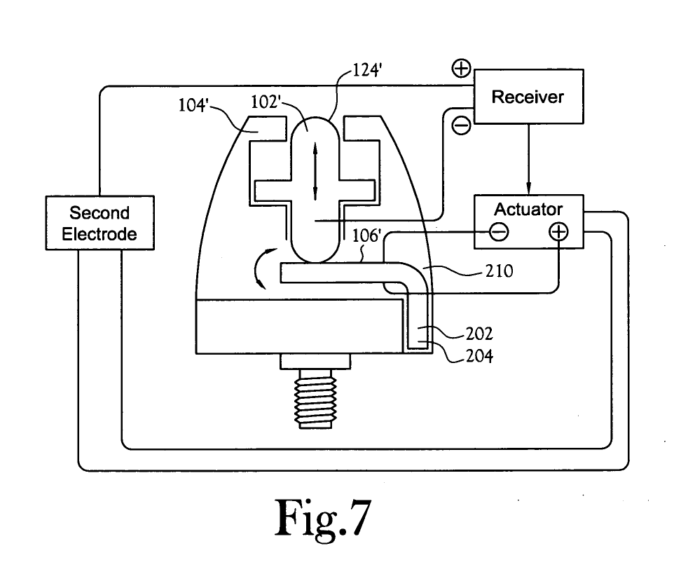

A further embodiment of the present invention is depicted in FIG. 7. Elements depicted in FIG. 7 which are common to elements depicted in FIG. 6 are identified by primed numerals. The electrode 200 depicted in FIG. 7 includes an electronically-actuated bimorph 202 mounted internally of the electrode housing 101′. In the depicted embodiment, one end 204 of a bimorph 202 is bent at about a 45 degree angle to define first and second legs 206,208, respectively, thereof. This bimorph, is mounted with one of its legs 206 anchored to the inner wall 210 of the electrode housing and with its other leg 208 extending in cantilevered fashion across the internal cavity 212 of the electrode housing. A distal tip 102′ is mounted in the outboard end 104′ of the electrode housing for reciprocatory movement of the distal tip between a first position wherein the distal tip is fully or substantially fully within the outboard end of the electrode housing and a second position wherein the distal tip is extended from the outboard end of the electrode housing a distance sufficient for the rounded end 124′ of the distal tip to engage the skin of pet to which the electroshock device is affixed. In one embodiment, the distal tip is biased inwardly of the outboard end of the electrode housing, as by a coiled spring 214 or the like. In this embodiment, upon the application of a dc voltage to the bimorph, the cantilevered second leg 208 thereof tends to straighten causing the leg to engage the distal tip and urge it outwardly from the outboard end of the electrode housing. Reversal of the polarity of the applied voltage results in the bimorph returning to its 45 degree bent attitude, allowing the distal tip to withdraw into the outboard end of the electrode housing and effect disengagement of the distal tip with the skin of the pet. Known circuitry may be employed to apply an electroshock to the pet while the distal tip is in electrically conductive engagement with the skin of the pet, (it being recognized that two electrodes are required for effecting the electroshock, but only one such electrode being depicted in either FIG. 8 or FIG. 7). Useful electronic activators may include the electronic polymers (electroactive, electrostatic, piezoelectric and ferroelectric). These polymers are driven by electric fields and can be made to hold the induced displacement under activation of a dc voltage. Electronic circuitry for control of the functioning of the electrode of FIG. 7 may be substantially the same as the electronic circuitry described hereinabove in connection with FIG. 6.

In either of the embodiments of FIG. 6 or 7, it will be recognized that electronic circuitry may be provided which coordinates the actuation of the distal tip movements and the application of an electroshock to the pet, so that at all times when no electroshock is needed or desired, the distal tip of each electrode will be out of physical engagement with the skin of the pet, but will be moved into electrically conductive engagement with the skin of the pet slightly before or substantially simultaneously with the application to the pet of an electroshock. As in others of the embodiments of the present invention set forth herein, in the embodiments depicted in FIGS. 6 and 7, the overall length of the electrode may be adjustable, as desired. As by means of the two-piece electrode housing feature descried herein, for example. The feature of the embodiment of the present invention wherein the distal tip is out of physical engagement with the pet until it is desired to apply an electroshock to the pet, is particularly beneficial for effectively eliminating any irritation or medical problem of the pet brought on by the continuous pressure of an electrode in firm engagement with the skin of the pet over extended periods of time.

Whereas various embodiments of the present invention are given herein, it will be recognized by one skilled in the art that each of these embodiments is amenable to variations which so not detract from the ultimate functioning of the electrodes and/or the type or degree of physical engagement of the electrodes to the skin of the pet and which do not depart from the scope and spirit of the present invention.

In accordance with one aspect of the present invention there is provided a method for reduction or elimination of irritation or medical problems associated with long term physically firm engagement of an electrode with the skin of a pet comprising the steps of providing an electrode of adjustable overall length in an electroshock-application device affixed to the pet, and selecting that overall length of the electrode which minimizes the firmness of physical engagement with the skin of the pet and simultaneously positions the electrode in electrically conductive engagement with the skin of the pet. In one embodiment, the method includes the step of physically separating the electrode from the skin of the pet at all times other than during the duration of application of an electroshock to the pet.

In any of the embodiments of the present invention depicted in the accompanying Figures, the distal tip may be formed of a relatively soft, flexible electrically conductive material such as metallic rubber, thereby providing for even greater comfort to the pet. Further, with respect to the embodiment depicted in FIG. 6, the distal tip may be eliminated altogether so that the electroactive polymer itself engages the skin of the pet. In this embodiment, either a positive or negative charge may be applied via the polymer to the pet, separate and apart from the electrical charge employed to effect expansion and contraction of the polymer.

1. An electrode useful in the application of an electroshock to a pet comprising
an electrode housing having an inboard end and an outboard end,
an electrically conductive distal tip disposed in said outboard end of said electrode housing,
an electrical conductor leading from said distal tip to an electrical power source connection,
said electrode housing being formed of multiple sections,
means for selectively adjusting the positions of said multiple sections of said electrode housing relative to one another to thereby adjust the overall length of said electrode housing.
Note: claim 1 would not cover that embodiment where the electroactive polymer serves as the conductor for the electroshock and there is no distal tip.

2. The electrode of claim 1 wherein said multiple sections of said electrode housing are threadably joined for relative rotational modification of the lineal overall length of said electrode housing.

3. The electrode of claim 1 wherein said distal tip is moveable linearly within said electrode housing between first and second positions, at least one of said first and second positions positioning said distal tip in electrically conductive engagement with the skin of the pet.

4. The electrode of claim 3 and including an ionic activated actuator for effecting linear movement of said distal tip within said electrode housing.

5. The electrode of claim 3 and including an electronic activated actuator for effecting linear movement of said distal tip within said electrode housing.

6. The electrode of claim 4 wherein said distal tip is disposed out of physical engagement with the skin of said pet at all times when electroshock is not being applied to the pet.

7. The electrode of claim 1 wherein said electrode housing is electrically insulative.

8. The electrode of claim 1 wherein said distal tip includes a rounded outboard end adapted to engage the skin of the pet.

9. An electrode useful in a device for the administration of an electroshock to a pet comprising
an electrode housing formed of an electrically insulative material and having an inboard end and an outboard end,
said electrode housing including multiple sections which are joined together at least one location intermediate said inboard end and said outboard end thereof; said joining together of said multiple sections providing for adjustable extension and contraction of said multiple sections relative to one another to thereby select the overall length of said electrode.

10. The electrode of claim 9 and including means defining a throughbore extending between said inboard and said outboard ends of said electrode housing and including an electrical conductor disposed in said throughbore.

11. The electrode of claim 10 and including an electrically conductive distal tip disposed at least partially within said throughbore adjacent said outboard end of said electrode housing.

12. The electrode of claim 111 and including means for replaceably mounting of said electrode in position on a pet for electrically conductive engagement with the skin of the pet.

13. The electrode of claim 12 wherein said means for replaceably mounting of said electrode comprises a threaded member disposed partially within said throughbore at a location adjacent said inboard end of said electrode housing

14. The electrode of claim 9 wherein said multiple sections of said electrode housing are joined together by means of mating threads whereby rotation of one or more of said multiple sections of said electrode housing effects increase or decrease of the overall length of said electrode housing.

15. The electrode of claim 11 wherein said electrical conductor comprises a coiled electrical conductor having a first end in electrically conductive engagement with said distal tip.

16. The electrode of claim 11 wherein said electrical conductor comprises a coiled spring of an electrically conductive material.

17. The electrode of claim 11 wherein said electrical conductor comprises a resilient and flexible electrically conductive material.

18. The electrode of claim 5 wherein said distal tip is disposed out of physical engagement with the skin of said pet at all times when an electroshock is not being applied to the pet.
